(19) United States
(12) Patent Application Publication
(10) Pub. No.: US 2006/0284952 A1
(43) Pub. Date: Dec. 21, 2006

(54) Positioning device for a large ink-jet printer

(76) Inventor: Jin-Sheng Lai, Hsi Chih City (TW)

Correspondence Address: LOWE HAUPTMAN BERNER, LLP, 1700 DIAGONAL ROAD, SUITE 300, ALEXANDRIA, VA, 22314, US

(21) Appl. No.: 11/155,679

(22) Filed: Jun. 20, 2005

(51) Int. Cl. B41J 2/01

(52) U.S. Cl. 347/104

(57) ABSTRACT

A positioning device for a large ink-jet printer, it comprises a supporting rack having on one end thereof a slide portion to be movably connected to rails provided on the ink-jet printer, and each having on the other end thereof a positioning portion; and a light beam emitter is connected to the positioning portion for emitting light beams to position the area that the material being printed is located at. Thereby, an operator can accurately position materials to be printed with various sizes according to the positions indicated and positioned by the light beams, and an effect of ink-jet printing can be completely achieved.

### BACKGROUND OF THE INVENTION

1. Field of the Invention

The present invention is related to a positioning device for a large ink-jet printer, and more particularly to a structure provided on a movable supporting rack with a light beam emitter to indicate the area that the material being printed is located at; this can make accurate positioning of materials to be printed with various sizes to achieve an effect of ink-jet printing.

2. Description of the Prior Art

In markets, to achieve the goal of marketing various commodities, normally the effect of advertisement is presented with outdoor measures including a large stage background, a back lightening or a car body advertising, and/or with indoor measures including decorative paints, commodity display promotion and showcase display etc., thus to attract customers' eye sights to achieve the object of sale.

As to production of the above stated various advertisement types, people in the art normally use a large ink-jet printer including at least a structure for ink jetting movable transversely on transverse rails on a machine to proceed to the action of ink jetting, to jet ink onto a cloth or a paper, thus an effect of ink-jet printing can be obtained.

A jet-drawing structure of the stated ink-jet printer can surely obtain the effect of ink-jet printing. However, by the reason that the materials being printed for a large ink-jet printer include different material with various hardness, thickness and sizes; in the past, before an operator proceeds in an ink-jet operation, he must place the material being printed on an operation platform in a visual observation mode; such mode of detecting and positioning is not accurate, and is subjected to making the scope of ink jetting over the width of the material being printed, thus ink is wasted, and inferiority of production is increased.

In view of the above defects to be solved, in order that a positioning device for a large ink-jet printer can conveniently and accurately position different materials to be printed with various sizes to completely achieve an effect of ink-jet printing, the inventor provides the present invention based on his professional experience of years and nonstop studying and improvement.

### SUMMARY OF THE INVENTION

The primary objective of the present invention is to provide a positioning device for a large ink-jet printer, by using a light beam emitter to emit positioning light beams above a material being printed, the position of the material being printed can be indicated accurately, and an effect of ink-jet printing can be completely achieved.

The secondary objective of the present invention is to provide a positioning device for a large ink-jet printer, by using a light beam emitter movably provided above a material being printed to adjust the positioning light beams, the positions being positioned can be adjusted in pursuance of the sizes of the material being printed.

Therefore, in order to achieve the objectives of the present invention, the positioning device for a large ink-jet printer of the present invention comprises a supporting rack and a light beam emitter. The supporting rack has on one end thereof a slide portion to be movably connected to a rail provided on the ink-jet printer, and has on the other end thereof a positioning portion. The light beam emitter is connected to the positioning portion for emitting light beams to position the area that the material being printed is located at.

Thereby, an operator can accurately position materials to be printed with various hardness, thickness and sizes according to the positions indicated and positioned by the light beams, and an effect of ink-jet printing can be completely achieved.

The present invention will be apparent after reading the detailed description of the preferred embodiment thereof in reference to the accompanying drawings.

### BRIEF DESCRIPTION OF THE DRAWINGS

FIG. 1 is a perspective view showing the appearance of an embodiment of the present invention for a large ink-jet printer;

FIG. 2 is a partially enlarged perspective view showing an “A” portion in FIG. 1;

FIG. 3 is an exploded perspective view of showing the elements of the embodiment of the present invention;

FIG. 4 is a schematic sectional view showing the state of angle adjustment of a positioning portion of the embodiment of the present invention;

FIG. 5 is another schematic sectional view showing the state of angle adjustment of the positioning portion of the embodiment of the present invention;

FIG. 6 is a schematic perspective view showing the state of light beam projection by a light beam emitter of the embodiment of the present invention; and

FIG. 7 is a schematic perspective view showing the state of light beam projection in the dot projecting mode by two light beam emitters of another embodiment of the present invention.

### DETAILED DESCRIPTION OF THE PREFERRED EMBODIMENT

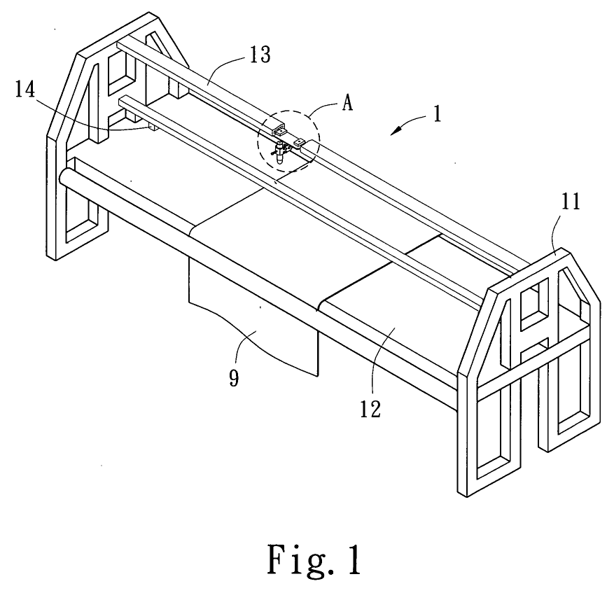

Referring firstly to FIG. 1, showing the state of an embodiment of the present invention cooperating with a large ink-jet printer 1, the ink-jet printer 1 comprises a main body 11 which has thereon a platform 12 for placing thereon a material 9 being printed; the platform 12 is provided thereon with two elongate rails 13, one of the rails 13 is installed thereon with an ink-jet printing device 14 for ink-jet printing under control on the material 9 being printed therebelow, the other rail 13 is provided for slide placing and then fixing of the present invention.

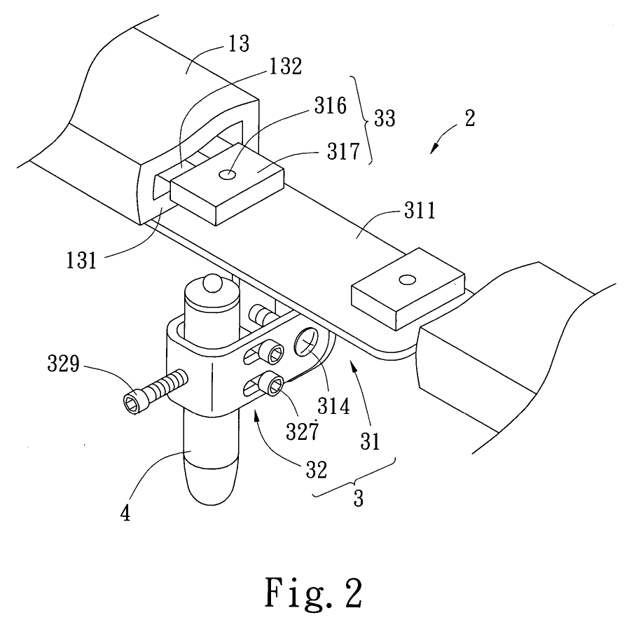

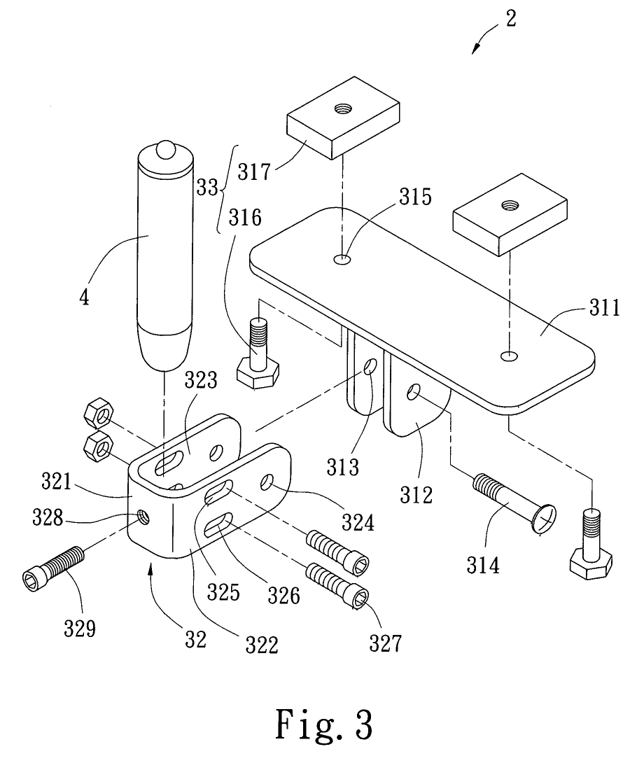

Referring to FIGS. 2-3 showing a preferred embodiment of a positioning device 2 of the present invention for a large ink-jet printer, the device 2 comprises a supporting rack 3 and a light beam emitter 4. The supporting rack 3 is made from plates, and has on one end thereof a slide portion 31, and has on the other end thereof a positioning portion 32. The slide portion 31 includes a plain plate 311 having two parallel upright plates 312 extending down from it, the upright plates 312 are provided thereon with holes 313 arranged coaxially for extending therethrough of a pivot axle 314; the plain plate 311 is provided at its two ends with through holes 315 for screw connecting with two engaging blocks 317 provided on the plain plate 311 after extending therethrough respectively of two fixing bolts 316, the two fixing bolts 316 and the two engaging blocks 317 form two locking sets 33.

The positioning portion 32 is a U shaped plate including a front plate portion 321 and two lateral plate portions 322 forming therebetween a receiving space 323 for receiving the light beam emitter 4; one end of the light beam emitter 4 can project light beams of the shapes of lines in sections. The two lateral plate portions 322 each has a hole 324 on one end thereof, and each has two elliptical holes 325, 326 symmetrically allocated at an upper and a lower position on the other end thereof; the hole 324 and the two elliptical holes 325, 326 all can be extended therethrough by bolts; the front plate portion 321 has thereon a screw hole 328 for connecting a screw rod, two of the bolts extending through the two elliptical holes 325, 326 function as an upper and a lower adjusting member 327, the screw rod functions as a fixing member 329.

The abovementioned elongate rails 13 of the large ink-jet printer 1 are hollow, bottom plates 131 of the rails 13 are formed to have elongate slits 132, the inner hollow portions of the rails 13 each can receive therein the two engaging blocks 317 of the two locking sets 33. When the plain plate 311 of the slide portion 31 on the supporting rack 3 is abutted against a bottom plate 131 of a rail 13, by extending of the two fixing bolts 316 of the locking sets 33 through an elongate slit 132, the bottom plate 131 of the rail 13 is clamped between the two engaging blocks 317 after the latter are locked together, thus the supporting rack 3 is fixed on the rail 13. The supporting rack 3 can be moved left and right on the rail 13 when the two fixing bolts 316 are loosened.

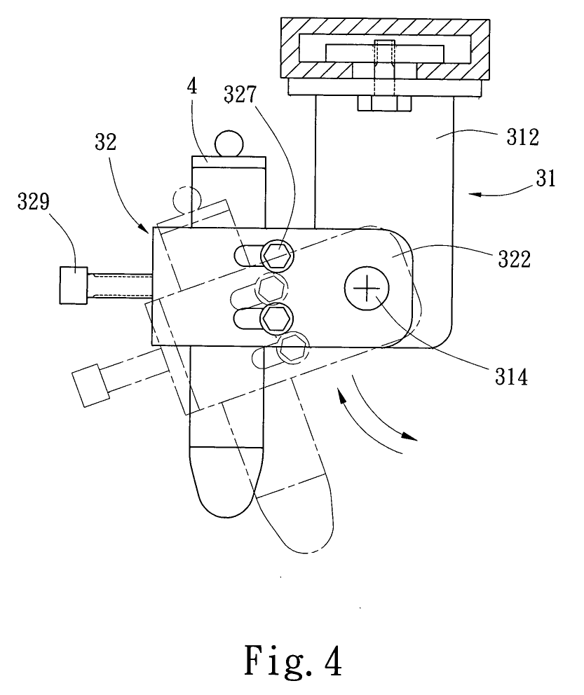

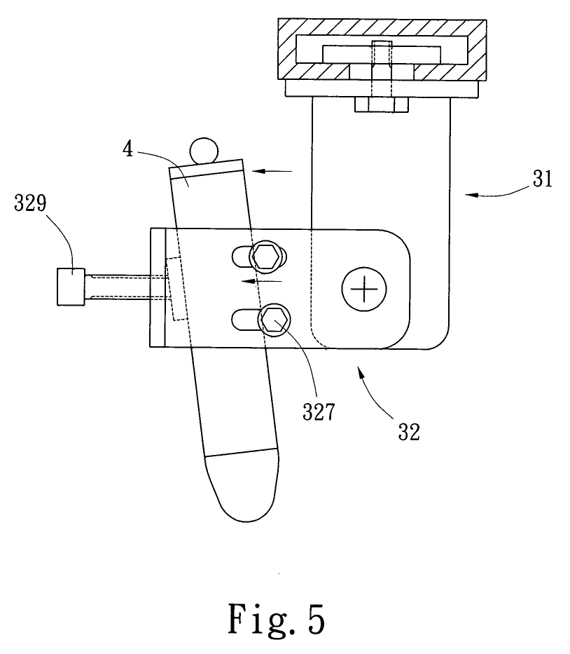

Referring to FIG. 4, the above stated holes 313 on the two parallel upright plates 312 of the slide portion 31 and the holes 324 on the two lateral plate portions 322 of the positioning portion 32 can be extended therethrough by the pivot axle 314 to form a state of pivot connection. When the positioning portion 32 is adjusted taking the slide portion 31 as a fulcrum and fixed at an angular position, light beams for positioning projected onto the platform 12 from one end of the light beam emitter 4 will move synchronically. The slide portion 31 and the positioning portion 32 can be integrally connected with each other, when the positions of the upper and the lower adjusting members 327 are adjusted and fixed, and the light beam emitter 4 is fixed with the fixing member 329, the light beam emitter 4 will be in an inclined angular position (as shown in FIG. 5), and the object of adjusting the projecting points for positioning can in the same way be achieved.

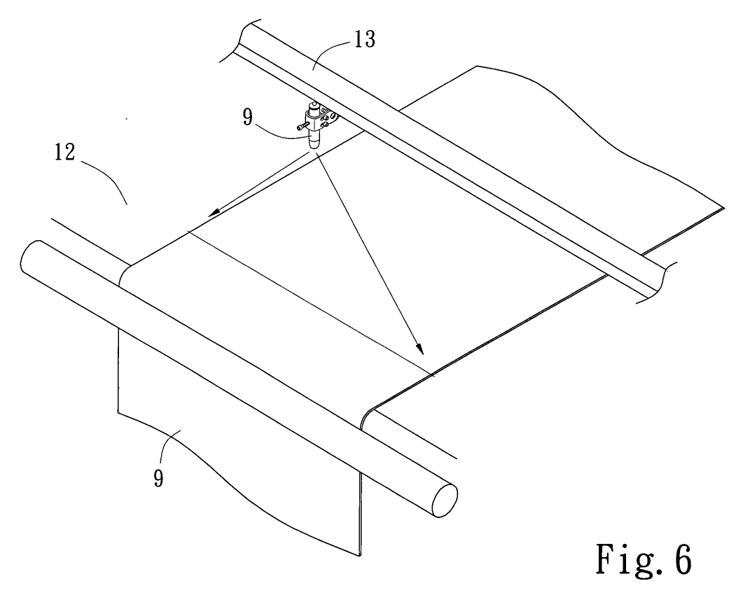

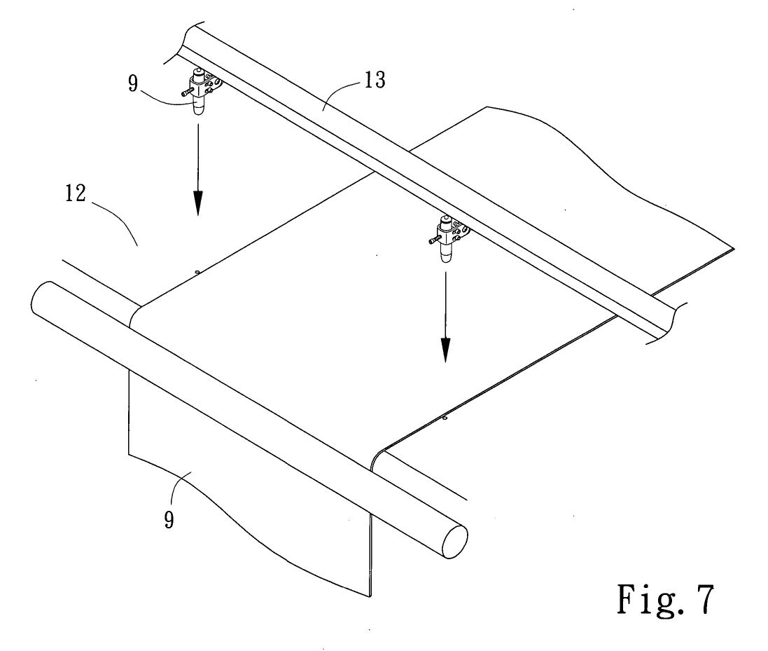

Referring to FIG. 6, by virtue that in the present embodiment, one end of the light beam emitter 4 can project light beams of the shapes of lines in sections, thereby in practical using, it needs only to have the light beam emitter 4, and effect of positioning can be obtained; if the light beams emitted by the light beam emitter 4 is in the shape of dots obtained by the dot projecting mode, two light beam emitters 4 are required and are connected to an identical rail 13 of the large ink-jet printer 1. By slide moving and fixing of the slide portion 31, projecting points can be formed individually; after an appropriate distance between two projecting points is obtained by adjustment, the material 9 being printed can be accurately positioned on the platform 12 (as shown in FIG. 7).

Therefore, the present invention has the following advantages:
1. By installing a light beam emitter above the material to be printed, the present invention can accurately indicate the area that the material to be printed and chosen from materials with various sizes is located at, and an effect of ink-jet printing can be completely gotten.
2. The present invention can use one or more than one light beam emitter in pursuance of requirement, it is quite flexible in application.
3. The present invention can slide move on rails, and can be fixed on the rails of an ink-jet printer, it can transversely adjust the projecting points in a fast and accurate way.
4. After mounting, the light beam emitter of the present invention can be adjusted to be in an inclined angular position, the projecting points can thus be moved longitudinally, this is quite convenient in operation.

In conclusion, according to the description disclosed above, the present invention surely can get the expected object thereof to provide a positioning device for a large ink-jet printer that can conveniently and accurately position the material to be printed and chosen from materials with various sizes to completely get the effect of ink-jet printing.

Having thus described the technical process of my invention having high industrial value, what I claim as new and desire to be secured by Letters Patent of the United States is:

1. A positioning device for a large ink-jet printer comprising:
a supporting rack having on one end thereof a slide portion to be movably connected to rails provided on said ink-jet printer, and having on the other end thereof a positioning portion; and
a light beam emitter connected to said positioning portion for emitting light beams to position an area that a material being printed is located at.

2. The positioning device for a large ink-jet printer as in claim 1, wherein: said slide portion is provided with locking sets, in order after moving of said supporting rack, said positioning device is fixed on said rails of said ink-jet printer.

3. The positioning device for a large ink-jet printer as in claim 1, wherein: said positioning portion is provided with a receiving space for receiving therein said light beam emitter.

4. The positioning device for a large ink-jet printer as in claim 1, wherein: said positioning device further has an upper and a lower adjusting member as well as a fixing member for connecting said positioning portion, in order to adjust light projecting angle of said light beam emitter.

5. The positioning device for a large ink-jet printer as in claim 1, wherein: said positioning portion is pivotally connected with said slide portion, in order to adjust an inclining angle of said positioning portion.

6. The positioning device for a large ink-jet printer as in claim 1, wherein: light beams projected from said light beam emitter are in the shapes of lines in sections.

7. The positioning device for a large ink-jet printer as in claim 1, wherein: said positioning device has two supporting racks each is identical to said supporting rack, and has two light beam emitters each is identical to said light beam emitter, in order that said positioning device is connected to one said rail; light beams projected from said light beam emitter are in the shapes of dots.
